(19) United States
(12) Patent Application Publication
(10) Pub. No.: US 2020/0168886 A1
(43) Pub. Date: May 28, 2020

(54) SECONDARY BATTERY

(71) Applicant: Panasonic Intellectual Property Management Co., Ltd., Osaka-shi, Osaka (JP)

(72) Inventors: Takao Sato, Osaka (JP); Kazuhiro Yoshii, Osaka (JP)

(73) Assignee: Panasonic Intellectual Property Management Co., Ltd., Osaka-shi, Osaka (JP)

(21) Appl. No.: 16/637,122

(22) PCT Filed: Jun. 28, 2018
(86) PCT No.: PCT/JP2018/024537

§ 371 Date: Feb. 6, 2020

(30) Foreign Application Priority Data
Sep. 11, 2017 (JP) 2017-173890

(51) Int. Cl. H01M 2/34; H01M 2/26

(52) U.S. Cl. CPC H01M 2/34; H01M 2/26

(57) ABSTRACT

A secondary battery includes an electrode body formed by layering a positive electrode and a negative electrode with a separator therebetween, an electrolyte, and insulating tape adhered to at least one of the positive electrode and the negative electrode. The insulating tape includes a base layer formed of an insulating organic material, an adhesive layer, and a porous layer that is interposed between the base layer and the adhesive layer and that has a pore that an electrolytic solution is allowed to enter.

### TECHNICAL FIELD

The present disclosure relates to a secondary battery.

### BACKGROUND ART

Regarding a non-aqueous electrolyte secondary battery, a configuration in which a positive electrode lead is connected to an exposed portion at which a surface of a current collector of a positive electrode is exposed and in which the lead is covered by adhering insulating tape has been known. At the portion to which the positive electrode lead is connected, compared with at the other portion of the positive electrode, the thickness of an electrode plate increases and pressure between electrode plates is likely to increase. Thus, an internal short circuit, for example, originating from conductive foreign matter is likely to occur. However, such an internal short circuit can be suppressed from occurring by adhering insulating tape to the positive electrode lead.

For example, PTL 1 discloses a non-aqueous electrolyte secondary battery including multi-layer insulating tape including an organic material layer formed of mainly an organic material and a composite material layer containing an organic material and an inorganic material.

### CITATION LIST

### Patent Literature

PTL 1: International Publication No. 2016/121339

### SUMMARY OF INVENTION

According to the art disclosed in PTL 1, the above-mentioned internal short circuit can be suppressed from occurring. However, when insulating tape to which a silica sol is added as an inorganic material is used, battery performance may degrade due to the silica sol reacting with an electrolytic solution. In addition, if an internal short circuit occurs due to conductive foreign matter penetrating the insulating tape, it is an important challenge to minimize spread of a short-circuited portion and to suppress a rise in battery temperature.

A secondary battery of an aspect according to the present disclosure includes an electrode body formed by layering a positive electrode and a negative electrode with a separator therebetween and an electrolytic solution. Each of the positive electrode and the negative electrode includes a current collector, a mixture layer formed on the current collector, and an electrode lead connected to an exposed portion at which a surface of the current collector is exposed. Insulating tape adhered to at least one of the electrode lead and the exposed portion is provided in at least one of the positive electrode and the negative electrode. The insulating tape includes a base layer formed of an insulating organic material, an adhesive layer, and a porous region that is interposed between the base layer and the adhesive layer and that has a pore that the electrolytic solution is allowed to enter.

With the secondary battery according to the present disclosure, an internal short circuit can be suppressed from occurring while favorable battery performance is maintained. In addition, even if an internal short circuit occurs, a rise in battery temperature can be suppressed.

### BRIEF DESCRIPTION OF DRAWINGS

FIG. 1 is a sectional view of a secondary battery of an example according to an embodiment.

FIG. 2 illustrates front views of a positive electrode and a negative electrode that constitute an electrode body of the example according to the embodiment.

FIG. 3 illustrates an electrode of another example according to the embodiment.

FIG. 4 is a sectional view of insulating tape of an example according to the embodiment.

FIG. 5 is a sectional view of insulating tape of another example according to the embodiment.

### DESCRIPTION OF EMBODIMENTS

A secondary battery according to the present disclosure can suppress an occurrence of an internal short circuit to a high degree while maintaining favorable battery performance by using insulating tape having a porous region between a base layer and an adhesive layer. When insulating tape containing a silica sol is used, an acidic component is formed by a side reaction between the silica sol and an electrolytic solution, a positive electrode active material is dissolved, and battery capacity may decrease. However, when the insulating tape according to the present disclosure is used, such a problem does not arise.

In addition, even if an internal short circuit occurs due to conductive foreign matter penetrating the insulating tape, a rise in battery temperature can be suppressed due to the electrolytic solution that has infiltrated into the porous region, that is, by evaporation heat of the electrolytic solution.

Hereinafter, an example according to the embodiment will be described in detail. A cylindrical battery in which a wound electrode body 14 is housed in a cylindrical battery case will be exemplified below. However, the battery case may also be a rectangular metal case (a rectangular battery) or a resin case formed of a resin film (a laminated battery), for example.

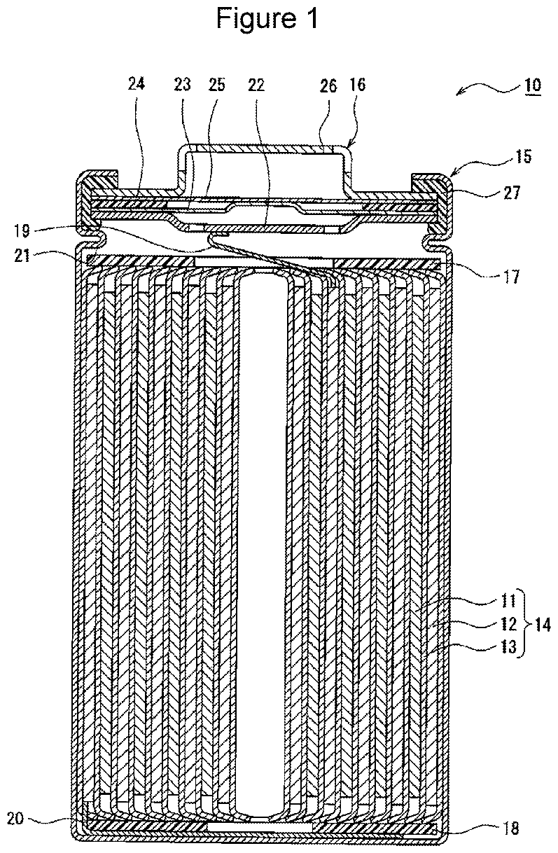

FIG. 1 is a sectional view of a secondary battery 10 of the example according to the embodiment. As exemplified in FIG. 1, the secondary battery 10 includes the electrode body 14, an electrolytic solution (not illustrated), and a battery case housing the electrode body 14 and the electrolytic solution. A preferable example of the secondary battery 10 is a lithium-ion battery. The electrode body 14 has a wound structure in which a positive electrode 11 and a negative electrode 12 are wound with a separator 13 therebetween. The battery case is configured of a bottomed cylindrical case body 15 and a sealing body 16 that seals an opening of the case body.

The electrolytic solution contains a solvent and an electrolyte salt dissolved in the solvent. Regarding a solvent, for example, water or a non-aqueous solvent may be used. Examples of the non-aqueous solvent include solvents of eaters, ethers, nitriles, and amides, and a mixed solvent of two or more of such solvents. Such a non-aqueous solvent may contain a halogen substitution product in which at least some hydrogen atoms in the solvent are substituted by halogen atoms such as fluorine. Regarding an electrolyte salt, for example, a lithium salt such as LiPF₆ is used.

The secondary battery 10 includes an insulating plate 17 disposed at the top of the electrode body 14 and an insulating plate 18 disposed at the bottom of the electrode body 14. In an example illustrated in FIG. 1, a positive electrode lead 19 passes through a through hole of the insulating plate 17 and extends toward the sealing body 16. A negative electrode lead 20 passes outside the insulating plate 18 and extends toward a bottom portion of the case body 15. The positive electrode lead 19 is connected to a lower surface of a filter 22, which is a bottom plate of the sealing body 16, by a welding process or the like, and a cap 26 that is a top panel of the sealing body 16, which is electrically connected to the filter 22, is to be a positive terminal. The negative electrode lead 20 is connected to an inner surface of the bottom portion of the case body 15 by a welding process or the like, and the case body 15 is to be a negative terminal.

The case body 15 is, for example, a bottomed cylindrical metal container. A gasket 27 is provided between the case body 15 and the sealing body 16, and hermeticity inside the battery case is thus maintained. The case body 15 has a protrusion portion 21 that is formed by, for example, pressing a side surface portion from outside and that supports the sealing body 16. The protrusion portion 21 is preferably formed into a ring shape so as to follow the circumference of the case body 15, and the protrusion portion 21 supports the sealing body 16 on the upper surface thereof.

The sealing body 16 has a multilayer structure in which the filter 22, a lower valve body 23, an insulating member 24, an upper valve body 25, and the cap 26 are layered in this order from the electrode body 14 side. Each member constituting the sealing body 16 has, for example, a disc shape or a ring shape, and the members except the insulating member 24 are electrically connected to each other. The lower valve body 23 and the upper valve body 25 are connected to each other at each center portion, and the insulating member 24 is interposed between circumferential edge portions of the lower valve body 23 and the upper valve body 25. The lower valve body 23 has a vent. When internal pressure of the battery increases due to abnormal heat generation, the upper valve body 25 expands toward the cap 26 and separates from the lower valve body 23. Thus, the electrical connection between the lower valve body 23 and the upper valve body 25 is interrupted. When the internal pressure increases further, the upper valve body 25 ruptures, and gas is released from an opening of the cap 26.

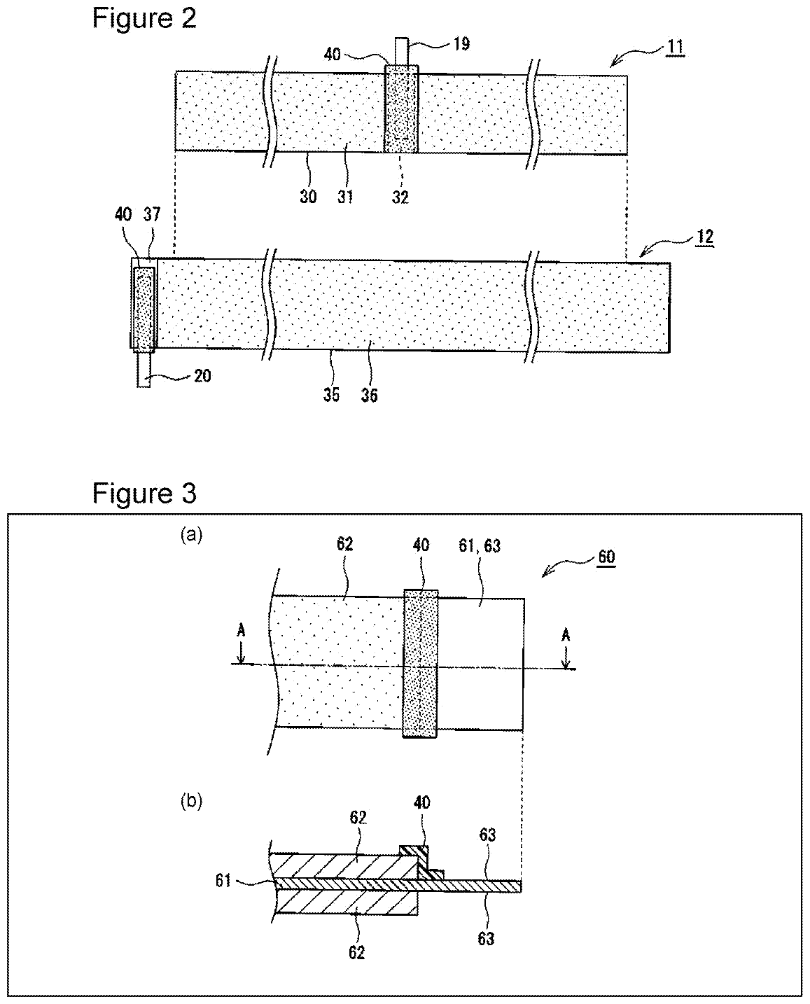

Hereinafter, the positive electrode 11 and the negative electrode 12, in particular, insulating tape 40 and insulating tape 50 that are adhered to respective electrode leads will be described in detail with reference to FIGS. 2 to 5. FIG. 2 illustrates front views of the positive electrode 11 and the negative electrode 12 that constitute the electrode body 14, and the right side of the figure is the core side of the winding of the electrode body 14.

As exemplified in FIG. 2, in the electrode body 14, the negative electrode 12 is formed larger than the positive electrode 11, and a current collector having a width and a length larger than those of a positive electrode current collector 30 of the positive electrode 11 is used for a negative electrode current collector 35 of the negative electrode 12 to suppress deposition of lithium on the negative electrode 12. At least a portion of the positive electrode 11, in which a positive electrode mixture layer 31 is formed, is disposed opposite a portion of the negative electrode 12, in which a negative electrode mixture layer 36 is formed, with the separator 13 therebetween.

The positive electrode 11 includes the positive electrode current collector 30, the positive electrode mixture layer 31 formed on the positive electrode current collector 30, and the positive electrode lead 19 connected to an exposed portion 32 at which a surface of the positive electrode current collector 30 is exposed. In the present embodiment, the positive electrode mixture layer 31 is formed on each of both surfaces of the belt-shaped positive electrode current collector 30. Regarding the positive electrode current collector 30, for example, a foil of a metal such as aluminum or a film including such a metal disposed as an outermost layer is used. The thickness of the positive electrode current collector 30 is, for example, 5 μm to 30 μm.

At both surfaces of the positive electrode current collector 30, the positive electrode mixture layer 31 is preferably formed over all surfaces, except for the exposed portion 32. The positive electrode mixture layer 31 contains a positive electrode active material, a conductive material such as carbon black or acetylene black, and a binder such as polyvinylidene fluoride (PVdF). An example of a positive electrode active material is a lithium metal composite oxide containing a metallic element such as Co, Mn, Ni, or Al. The positive electrode 11 can be formed in a manner such that each of both surfaces of the positive electrode current collector 30 is coated with a positive electrode mixture slurry containing a positive electrode active material, a conductive material, a binder, and a dispersion medium such as N-methyl-2-pyrrolidone (NMP), and the coating is compressed.

The exposed portion 32 is a portion of the surface of the positive electrode current collector 30 and is not covered with the positive electrode mixture layer 31. The exposed portion 32 is formed, for example, across the width of the positive electrode 11 and formed wider than the positive electrode lead 19. The exposed portion 32 is preferably provided at each of both surfaces of the positive electrode 11 in a manner such that the exposed portions 32 are superposed with each other in the thickness direction of the positive electrode 11. In an example illustrated in FIG. 2, the exposed portion 32 is provided on each surface of the positive electrode 11 at a center portion in the longitudinal direction of the positive electrode 11.

The negative electrode 12 includes the negative electrode current collector 35, the negative electrode mixture layer 36 formed on the negative electrode current collector 35, and the negative electrode lead 20 connected to an exposed portion 37 at which a surface of the negative electrode current collector 35 is exposed. In the present embodiment, the negative electrode mixture layer 36 is formed on each of both surfaces of the belt-shaped negative electrode current collector 35. Regarding the negative electrode current collector 35, for example, a foil of a metal such as copper or a film including such a metal disposed as an outermost layer is used. The thickness of the negative electrode current collector 35 is, for example, 5 μm to 30 μm.

At both surfaces of the negative electrode current collector 35, the negative electrode mixture layer 36 is preferably formed over all surfaces, except for the exposed portion 37. The negative electrode mixture layer 36 contains a negative electrode active material and a binder such as styrene-butadiene rubber (SBR). A material for a negative electrode active material is not particularly limited provided that the material can reversibly intercalate and deintercalate lithium ions. For example, a carbon material such as natural graphite or artificial graphite, a metal such as Si or Sn that can be alloyed with lithium or an alloy containing such metals, or a composite oxide can be used. The negative electrode 12 can be formed in a manner such that each of both surfaces of the negative electrode current collector 35 is coated with a negative electrode mixture slurry containing a negative electrode active material, a binder, water, and the like, and the coating is compressed.

The exposed portion 37 is a portion of the surface of the negative electrode current collector 35 and is not covered with the negative electrode mixture layer 36. The exposed portion 37 is formed, for example, across the width of the negative electrode 12 and formed wider than the negative electrode lead 20. The exposed portion 37 is preferably provided at each of both surfaces of the negative electrode 12 in a manner such that the exposed portions 37 are superposed with each other in the thickness direction of the negative electrode 12. In the example illustrated in FIG. 2, the exposed portion 37 is provided on each surface of the negative electrode 12 at an end portion in the longitudinal direction of the negative electrode 12, that is, the end portion on the outer side of the winding of the electrode body 14.

The positions of the exposed portions 32 and 37 are not particularly limited. For example, the exposed portion 37 may be provided at an end portion of the negative electrode 12 on the core side of the winding of the electrode body 14 (the other end portion in the longitudinal direction of the negative electrode 12) or may be provided on each of both end portions in the longitudinal direction of the negative electrode 12.

Each of the positive electrode lead 19 and the negative electrode lead 20 is a belt-shaped conductive member having a thickness larger than the thickness of the current collector and the thickness of the mixture layer. The thickness of each lead is, for example, 50 μm to 500 μm. The material forming each lead is not particularly limited. However, the positive electrode lead 19 is preferably formed of a metal containing mainly aluminum, and the negative electrode lead 20 is preferably formed of a metal containing mainly nickel or copper. The number, the positions, and the like of the leads are not particularly limited.

The secondary battery 10 includes, in at least one of the positive electrode 11 and the negative electrode 12, the insulating tape 40 adhered to at least one of the electrode lead and the exposed portion. The insulating tape 40 is preferably adhered to at least a portion of a portion of the electrode lead positioned on the current collector (may be referred to as “a base portion” hereinafter). The base portion of each electrode lead is typically welded to a corresponding one of the exposed portions 32 and 37; however, the entire base portion is not necessarily welded. A portion of the positive electrode lead 19 extends from an upper end of the positive electrode current collector 30 to be connected to the sealing body 16, and a portion of the negative electrode lead 20 extends from a lower end of the negative electrode current collector 35 to be connected to the inner surface of the bottom portion of the case body 15 (each of the portions may be referred to as “an extended portion” hereinafter).

In the example illustrated in FIG. 2, pieces of the insulating tape 40 are adhered to both of the positive electrode 11 and the negative electrode 12 and cover at least portions of the base portions of the respective electrode leads. At each portion to which the corresponding electrode lead is connected, compared with at the other portion of each electrode, pressure between the electrode plates is likely to increase as described above. Thus, an internal short circuit originating from conductive foreign matter is likely to occur. However, such an internal short circuit can be suppressed from occurring by providing the insulating tape 40. The insulating tape 40 may be adhered to only the positive electrode 11, and known insulating tape without a porous layer 43, which will be described below, may be adhered to the negative electrode 12. Alternatively, insulating tape 50, which will be described below, may be used instead of the insulating tape 40.

When viewed from the front, the insulating tape 40 has, for example, a rectangular shape (a strip shape) wider than the electrode lead. The insulating tape 40 is preferably adhered so as to cover the entire base portion of the electrode lead. In the example illustrated in FIG. 2, the entire base portion of the positive electrode lead 19 and the entire exposed portion 32 are covered with the insulating tape 40. A portion of the insulating tape 40 is also adhered to the positive electrode mixture layer 31 formed on both lateral sides of the exposed portion 32. In addition, the insulating tape 40 is also preferably adhered to an exposed portion 32 formed at the surface that is opposite to the exposed portion 32 at the surface to which the positive electrode lead 19 is welded. That is, pieces of the insulating tape 40 are adhered to both respective surfaces of the positive electrode 11 while covering the respective exposed portions 32.

In addition, the insulating tape 40 may be adhered to a root of the extended portion of the positive electrode lead 19 beyond the range of the positive electrode current collector 30. The root portion of the extended portion of the positive electrode lead 19 is opposite the negative electrode 12 with the separator 13 therebetween; thus, there is a concern that an internal short circuit originating from melting of the separator 13 may occur. Therefore, the insulating tape 40 is preferably also adhered to the root portion. The edge tape 40 is also adhered to the negative electrode lead 20 and the exposed portion 37 as with the positive electrode 11. In the example illustrated in FIG. 2, the insulating tape 40 is adhered so as to cover the entire base portion of the negative electrode lead 20 and a portion of the exposed portion 37.

FIG. 3 illustrates an electrode 60 to which the insulating tape 40 is adhered; (a) is a front view, and (b) is a sectional view taken from line A-A in (a). The electrode 60 may be a positive electrode or a negative electrode. As exemplified in FIG. 3, the insulating tape 40 may be adhered to the electrode 60 so as to provide coverage along a boundary portion between a mixture layer 62 and an exposed portion 63 of a current collector 61. In an example illustrated in FIG. 3, the insulating tape 40 is adhered over an end portion of the mixture layer 62 and the exposed portion 63. The insulating tape 40 may be adhered to a surface of the electrode 60 or to both surfaces of the electrode 60.

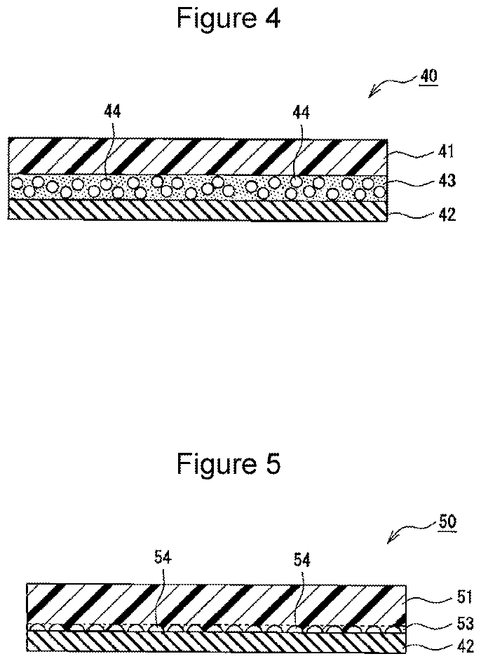

FIG. 4 is a sectional view of the insulating tape 40 of an example according to the embodiment. As exemplified in FIG. 4, the insulating tape 40 includes a base layer 41 containing an insulating organic material, an adhesive layer 42, and a porous layer 43 that is interposed between the base layer 41 and the adhesive layer 42 and that has pores 44 that an electrolytic solution is allowed to enter. The porous layer 43 is formed of a resin and forms a porous region between the base layer 41 and the adhesive layer 42. The porous region is not limited to a porous region that is formed by interposing the porous layer 43 between the base layer 41 and the adhesive layer 42, and the porous region may be formed of protrusions and depressions in a surface of a base layer on the adhesive layer side (see FIG. 5, which will be described below).

The insulating tape 40 suppresses an occurrence of an internal short circuit without affecting battery performance. In addition, even if an internal short circuit occurs due to conductive foreign matter penetrating the tape, a rise in battery temperature can be suppressed by evaporation heat of the electrolytic solution in the pores 44 of the porous layer 43. The porous layer 43 is provided at least between the base layer 41 and the adhesive layer 42 and may be formed on the surface of the base layer 41 on a side opposite to the adhesive layer 42. That is, the porous layer 43 may be formed on each of both surfaces of the base layer 41.

The thickness of the insulating tape 40 is, for example, 15 μm to 70 μm, preferably 20 μm to 70 μm. The thicknesses of the insulating tape 40 and the layers can be measured by cross-sectional observation using a scanning electron microscope (SEM). The insulating tape 40 may have a layered structure including four or more layers. For example, the base layer 41 is not limited to a single-layer structure and may be formed of a layered film including two or more layers that are formed of the same kind of materials or different kinds of materials.

The base layer 41 is preferably formed of substantially only an organic material. The ratio of an organic material to the entire materials forming the base layer 41 is, for example, 90% or more by weight, preferably 95% or more by weight, or may even be 100% by weight. The main component of an organic material is preferably a resin that has favorable properties in terms of, for example, insulation performance, electrolytic solution resistance, heat resistance, and penetrating resistance. The thickness of the base layer 41 is preferably larger than the thickness of the adhesive layer 42 and the thickness of the porous layer 43 and is, for example, 10 μm to 45 μm, preferably 15 μm to 35 μm. The base layer 41 may contain inorganic particles (alumina, titania, etc.) as a material other than the organic material.

Preferable examples of resins to form the base layer 41 are polyesters such as polyethylene terephthalate (PET), polypropylene (PP), polyimide (PI), polyphenylene sulfide, and polyamide. Such resins may be used alone or in a combination of two or more resins. Above all, polyimide that has high mechanical strength (penetrating resistance) is particularly preferable. Regarding the base layer 41, a resin film formed of, for example, polyimide can be used.

The adhesive layer 42 is a layer for adding an adhesive property to the insulating tape 40 to the positive electrode lead 19. The adhesive layer 42 is formed in a manner such that, for example, one of the surfaces of a combined layer in which the porous layer 43 is formed on the base layer 41 is coated with an adhesive. The adhesive layer 42 is preferably formed by using an adhesive (a resin) having favorable properties such as insulation performance and electrolytic solution resistance, as with the base layer 41. An adhesive forming the adhesive layer 42 may be a hot-melt adhesive that exhibits viscosity by heating or a thermosetting adhesive that is cured by heating. From the perspective of productivity and the like, an adhesive having viscosity at room temperature is preferable. An example of an adhesive forming the adhesive layer 42 is an acrylic adhesive or a synthetic rubber adhesive. The adhesive layer 42 has a thickness of, for example, 5 μm to 30 μm and is formed thicker than the porous layer 43.

The porous layer 43 forming the porous region is a porous resin layer having a plurality of pores 44 as described above. A resin forming the porous layer 43 preferably has favorable properties such as insulation performance and electrolytic solution resistance, as with the base layer 41, and the resin preferably has a favorable adhesive property to the base layer 41. The porous layer 43 is formed of, as a main component, a kind selected from a group consisting of polyimide, polyamide, aramid resin, epoxy resin, and acrylic resin, for example. Above all, from the perspective of suppressing a rise in temperature at the time a short circuit occurs, an acrylic resin is preferable. Here, the main component refers to the component that has the heaviest weight in the resins forming the porous layer 43.

The porous layer 43 can be formed in a manner such that, for example, a filler that is to be dissolved in a predetermined solvent is added to a resin solution or to an uncured resin to form a dispersion element. After one of the surfaces of the base layer 41 is coated with the dispersion element, the filler is removed by elution. The elution of the filler is preferably performed after the coating is cured by, for example, solvent evaporation, irradiation with light, or heat treatment. Examples of a filler are alkali metal salts soluble in water such as sodium chloride and carbonic acid esters soluble in the non-aqueous solvent of the electrolytic solution. When carbonic acid esters are used, the pores 44 are formed by, for example, elution of carbonic acid esters into the electrolytic solution inside the battery. Alternatively, the pores 44 can be formed by foaming a resin layer by adding a foaming agent, instead of adding a filler that can be removed by elution.

The thickness of the porous layer 43 (the porous region) is, for example, 0.1 μm to 15 μm, preferably 0.5 μm or more. In addition, the thickness of the porous layer 43 may be modified as appropriate in accordance with the thickness of the base layer 41. As a preferable example, the ratio of the thickness of the porous layer 43 to the total thickness of the base layer 41 and the porous layer 43 (thickness of porous layer 43×100/[thickness of base layer 41+thickness of porous layer 43]) is 2% to 30%, more preferably 3% to 10%. When the thickness of the porous layer 43 is within the range, a rise in temperature at the time a short circuit occurs is easily suppressed.

The pores 44 in the porous layer 43 are filled with an electrolytic solution. The pores 44 are connected to each other from one end surface of the porous layer 43 to the other end surface by, for example, communicating with each other, thereby forming, inside the layer, a flow passage for the electrolytic solution. Not all the pores 44 may necessarily be filled with the electrolytic solution, and the porous layer 43 may have a closed pore 44 that the electrolytic solution does not enter. Even when the volume of each pore 44 in the porous layer 43 is increased, favorable penetrating resistance of the insulating tape 40 can be maintained by providing the base layer 41 and by interposing the porous layer 43 between the base layer 41 and the adhesive layer 42.

The porosity of the porous layer 43 is preferably at least 5% or more of the layer volume. Here, porosity is the ratio of the volume of the pores 44 to the total volume (the volume including the pores 44) of the porous layer 43. The porosity can be measured by cross-sectional observation of the insulating tape 40 using an SEM or can be obtained from the added amount of the above-described filler when the added amount of the filler is given. The porosity of the porous layer 43 is preferably 10% to 60% by volume, more preferably 30% to 50% by volume. When the porosity is within the range, a rise in temperature at the time a short circuit occurs can be sufficiently suppressed while the strength of the insulating tape 40 is maintained.

FIG. 5 is a sectional view of the insulating tape 50 of another example according to the embodiment. In FIG. 5, components that are similar to those of the insulating tape 40 illustrated in FIG. 4 are denoted by the same numbers as those denoted in FIG. 4. As exemplified in FIG. 5, the insulating tape 50 includes a base layer 51, the adhesive layer 42, and a porous region 53 that is interposed between the base layer 51 and the adhesive layer 42 and that has pores 54 that an electrolytic solution is allowed to enter. That is, the configuration of the insulating tape 50 differs from that of the insulating tape 40 in that the porous region 53 is provided instead of the porous layer 43. Functions and advantageous effects that are similar to those attained when the insulating tape 40 is used can also be attained when the insulating tape 50 is used.

The porous region 53 is formed of protrusions and depressions in the surface of the base layer 51 on the adhesive layer 42 side. The base layer 51 has the protrusions and the depressions in the surface, in which, for example, the depressions have a depth of about 0.1 μm to 15 μm. In the insulating tape 50, the adhesive layer 42 is provided so as not to fill the depressions in a manner such that, for example, the surface of the base layer 51 in which the protrusions and the depressions are formed is laminated with a resin film that forms the adhesive layer 42. Consequently, the porous region 53 in which the depressions are to be the pores 54 is formed. The protrusions and the depressions in the surface of the base layer 51 may be irregularly formed or regularly formed by, for example, providing a groove-shaped depression. The thickness of the porous region 53 is, for example, 0.1 μm to 15 μm, preferably 0.5 μm or more.

The pores 54 are filled with an electrolytic solution as with the pores 44 of the porous layer 43. The pores 54 are connected to each other from one end surface of the porous layer 43 to the other end surface by, for example, communicating with each other or having a groove shape, thereby forming, inside the layer, a flow passage for the electrolytic solution. However, not all the pores 54 may necessarily be filled with the electrolytic solution. The porous region 53 is preferably formed of, as a main component, a kind selected from a group consisting of polyimide, polyamide, aramid resin, epoxy resin, and acrylic resin. Above all, the porous region 53 is preferably formed of an acrylic resin as a main component.

### EXAMPLES

Hereinafter, the present disclosure will be further described with reference to examples. However, the present disclosure is not limited to the following examples.

### Example 1

### [Positive Electrode Manufacture]

A positive electrode mixture slurry was prepared in a manner such that 100 parts by weight of a lithium nickel cobalt aluminum composite oxide expressed by LiNi_{0.88}Co_{0.09}Al_{0.03}O₂ as a positive electrode active material, 1 part by weight of acetylene black (AB), and 1 part by weight of polyvinylidene fluoride (PVdF) were mixed with each other, and an appropriate amount of N-methyl-2-pyrrolidone (NMP) was further added. Next, both surfaces of a positive electrode current collector formed of an aluminum foil were coated with the positive electrode mixture slurry, and the coating was dried. After the current collector on which the coating had been formed was compressed by a roller, the current collector was cut to form a portion of a predetermined electrode size, and a positive electrode in which positive electrode mixture layers were formed on both surfaces of the positive electrode current collector was formed. Exposed portions, at which the mixture layers were not formed and the surfaces of the current collector were thus exposed, were provided at a center portion in the longitudinal direction of the positive electrode, and a positive electrode lead of aluminum was ultrasonically welded to the corresponding exposed portion.

Insulating tape was adhered to the positive electrode so as to cover a base portion and a root portion of an extended portion of the positive electrode lead, and each of the exposed portions. The layer configuration of the insulating tape is as follows.

Base layer: polyimide film

Adhesive layer: acrylic adhesive layer

Porous layer: refer to Table 1 for composition, porosity (units expressed in vol %), and thickness (units expressed in %)

The porous layer was formed by the following method.

In a curable acrylic resin, the amount corresponding to 30% by volume of sodium chloride powder was dispersed, and a surface of the polyimide film was coated with the above resin so that the thickness of the porous layer became 2% (after curing) relative to the total thickness of the base layer (the polyimide film) and the porous layer. The coating was then cured. Next, the sodium chloride that was dispersed in the acrylic resin was removed by elution in a manner such that the acrylic resin was immersed in warm water at 60° C. for one hour, and the porous layer having a plurality of pores was obtained. After the polyimide film on which the porous layer was formed was dried, an acrylic adhesive was applied onto the porous layer to form the adhesive layer.

### [Negative Electrode Manufacture]

A negative electrode mixture slurry was prepared in a manner such that 98 parts by weight of graphite powder, 1 part by weight of sodium carboxymethyl cellulose (CMC-Na), and 1 part by weight of styrene-butadiene rubber (SBR) were mixed with each other, and an appropriate amount of water was further added. Next, both surfaces of a negative electrode current collector formed of a copper foil were coated with the negative electrode mixture slurry, and the coating was dried. After the current collector on which the coating was formed was compressed by a roller, the current collector was cut to form a portion of a predetermined electrode size, and a negative electrode in which negative electrode mixture layers were formed on both surfaces of the negative electrode current collector was formed. Exposed portions, at which the mixture layers were not formed and the surfaces of the current collector were thus exposed, were provided at an end portion in the longitudinal direction of the negative electrode (a portion to be an end portion on the outer side of the winding), and a negative electrode lead of nickel was ultrasonically welded to the corresponding exposed portion.

The above-described insulating tape was adhered to the negative electrode so as to cover a base portion and a root portion of an extended portion of the negative electrode lead, and each exposed portion.

### [Electrolyte Preparation]

Ethylene carbonate (EC), ethyl methyl carbonate (EMC), and dimethyl carbonate (DMC) were mixed with each other in the volume ratio of 3:3:4. LiPF₆ was dissolved in the mixed solution at a concentration of 1 mol/L to prepare a non-aqueous electrolyte.

### [Battery Manufacture]

A wound electrode body was manufactured in a manner such that the above-described positive electrode and negative electrode were wound into a helical form with a separator therebetween. The separator is formed of a porous film of polyethylene, and a heat-resistant layer in which a filler of polyamide and alumina dispersed was formed on a surface of the separator. After the electrode body was placed in a bottomed cylindrical metal case body (outer diameter 18 mm; height 65 mm), the extended portion of the positive electrode lead was welded to a filter of a sealing body, and the extended portion of the negative electrode lead was welded to an inner surface of a bottom portion of the case body. The above-described non-aqueous electrolytic solution was poured into the case body, and an opening of the case body was closed with the sealing body to manufacture a cylindrical 18650 battery.

### Examples 2 to 22

Cylindrical batteries were manufactured as with Example 1; however, a layered structure of the insulating tape used in Example 1 was modified as shown in Table 1. As a resin for forming a porous layer, an epoxy resin was used in Examples 19 and 20, and an aramid resin was used in Examples 21 and 22.

### Comparative Example 1

A cylindrical battery was manufactured as with Example 1; however, insulating tape (insulating tape formed of a polyimide film and an acrylic adhesive layer) without a porous layer was used.

### Comparative Example 2

A cylindrical battery was manufactured as with Example 1; however, instead of a porous layer, an intermediate layer formed of a curable acrylic resin was provided (sodium chloride was not added).

### Comparative Example 3

A cylindrical battery was manufactured as with Example 19; however, instead of a porous layer, an intermediate layer formed of an epoxy resin was provided (sodium chloride was not added).

### Comparative Example 4

A cylindrical battery was manufactured as with Example 21; however, instead of a porous layer, an intermediate layer formed of an aramid resin was provided (sodium chloride was not added).

### Comparative Example 5

A cylindrical battery was manufactured as with Example 2; however, instead of a porous layer, an intermediate layer containing a silica sol was provided. The intermediate layer was formed in a manner such that the amount corresponding to 30% by volume of silica sol powder was dispersed in a curable acrylic resin, and the resin was applied onto a surface of the polyimide film so that the porous layer has a thickness of 5% relative to the total thickness of the base layer (a polyimide film) and the porous layer.

A foreign matter-originating short circuit test and a conservation test for each battery of the examples and the comparative examples were conducted using the following methods. Test results are shown in Tables 1 and 2.

### [Foreign Matter-Originating Short Circuit Test]

Each battery was charged at a constant current value of 500 mA until a final voltage of 4.2 V was attained, and each battery was then charged at a constant voltage of 4.2 V for 60 minutes. Conductive foreign matter was placed between a portion of the positive electrode lead to which the insulating tape was adhered and the separator, and the temperature of an side surface of the battery was measured by using a thermocouple at the time a short circuit was forcibly caused in accordance with the JIS C8714 test. The test results, which are temperature rise values at the time a foreign matter-originating short circuit was caused, are shown in Tables 1 and 2.

### [Conservation Test]

Each battery was charged at a constant current value of 500 mA until a final voltage of 4.2 V was attained, and each battery was then charged at a constant voltage of 4.2 V for 60 minutes. After each charged battery had been conserved in an open-circuit state at a temperature of 60° C. for one month, each battery was discharged at a constant current value of 500 mA until a final discharge voltage of 2.5 V was attained, and the ratio of discharge capacity to charge capacity was calculated. The results are shown in Tables 1 and 2, as relative values to a calculated value of the battery of Comparative Example 1. The relative value to the value of Comparative Example 1 refers to the capacity decreasing ratio (%) after charging and conservation of each of the other batteries relative to the battery of Comparative Example 1, and the relative value can be obtained by the following equation. Charge and discharge in the examples and the comparative examples were performed in an environment at 25° C.

Capacity decreasing ratio after charging and conservation (%)=[1−(discharge capacity of Example n or Comparative Example m/charge capacity of Example n or Comparative Example m)/(discharge capacity of Comparative Example 1/charge capacity of Comparative Example 1)]×100

Here, Example n refers to any one of the batteries of Examples 1 to 22, and Comparative Example m refers to any one of the batteries of Comparative Examples 1 to 5.

TABLE 1

| | | | | | | Temperature | Capacity |
|---|---|---|---|---|---|---|---|
| | | | | | | rise at | decreasing |
| | | Porous layer (Layer B) | | | | foreign matter- | ratio after |
| | Base layer | | | Thickness | | originating | charging and |
| | (Layer A) | | Porosity/ | ratio B/ | Adhesive layer | short circuit/ | conservation |
| | Thickness/μm | Composition | vol % | (A + B) | Thickness/μm | ° C. | (%) |
| Example 1 | 25 | Acryl | 30 | 2 | 10 | 4 | <1 |
| Example 2 | 25 | Acryl | 50 | 5 | 10 | 3 | <1 |
| Example 3 | 25 | Acryl | 30 | 5 | 10 | 2 | <1 |
| Example 4 | 25 | Acryl | 5 | 5 | 10 | 6 | <1 |
| Example 5 | 25 | Acryl | 30 | 10 | 10 | 3 | <1 |
| Example 6 | 25 | Acryl | 30 | 30 | 10 | 3 | <1 |
| Example 7 | 15 | Acryl | 30 | 2 | 10 | 2 | <1 |
| Example 8 | 15 | Acryl | 50 | 5 | 10 | <1 | <1 |
| Example 9 | 15 | Acryl | 30 | 5 | 10 | 2 | <1 |
| Example 10 | 15 | Acryl | 5 | 5 | 10 | 1 | <1 |
| Example 11 | 15 | Acryl | 30 | 10 | 10 | 3 | <1 |
| Example 12 | 15 | Acryl | 30 | 30 | 10 | 5 | <1 |
| Example 13 | 25 | Acryl | 30 | 2 | 5 | 3 | <1 |
| Example 14 | 25 | Acryl | 50 | 5 | 5 | 2 | <1 |
| Example 15 | 25 | Acryl | 30 | 5 | 5 | 2 | <1 |
| Example 16 | 25 | Acryl | 5 | 5 | 5 | 5 | <1 |
| Example 17 | 25 | Acryl | 30 | 10 | 5 | 3 | <1 |
| Example 18 | 25 | Acryl | 30 | 30 | 5 | 3 | <1 |
| Example 19 | 25 | Epoxy | 50 | 5 | 10 | 21 | 3 |
| Example 20 | 25 | Epoxy | 10 | 5 | 10 | 25 | 3 |
| Example 21 | 25 | Aramid | 50 | 5 | 10 | 12 | 2 |
| Example 22 | 25 | Aramid | 5 | 5 | 10 | 19 | 1 |

TABLE 2

| | | | | | | Temperature | Capacity |
|---|---|---|---|---|---|---|---|
| | | | | | | rise at | decreasing |
| | | Porous layer (Layer B) | | | | foreign matter- | ratio after |
| | Base layer | | | Thickness | Adhesive | originating | charging and |
| | (Layer A) | | Porosity/ | ratio B/ | layer | short circuit/ | conservation |
| | Thickness/μm | Composition | vol % | (A + B) | Thickness/μm | ° C. | (%) |
| Comparative | 25 | — | — | — | 10 | 53 | — |
| Example 1 | | | | | | | |
| Comparative | 25 | Acryl | 0 | 5 | 10 | 46 | <1 |
| Example 2 | | | | | | | |
| Comparative | 25 | Epoxy | 0 | 5 | 10 | 55 | 3 |
| Example 3 | | | | | | | |
| Comparative | 25 | Aramid | 0 | 5 | 10 | 45 | 3 |
| Example 4 | | | | | | | |
| Comparative | 25 | Acryl | Silica | 5 | 10 | 6 | 18 |
| Example 5 | | | sol | | | | |

As shown in Tables 1 and 2, compared with the batteries of the comparative examples, in the battery of each example, a rise in temperature at the time a foreign matter-originating short circuit is caused is suppressed, and the capacity decreasing ratio after charging and conservation is low. According to the battery of Comparative Example 5 in which the insulating tape containing a silica sol is used, a rise in temperature at the time a short circuit is caused can be suppressed; however, the capacity decreasing ratio after charging and conservation is large. A side reaction between the silica sol and the electrolytic solution is considered to be a factor.

In addition, in the battery of each example, heat generated by a short circuit was consumed due to evaporation of the electrolytic solution with which the porous layer was filled. Thus, the heat consumption is considered to have resulted in suppressing a rise in battery temperature. That is, due to a function of the porous layer, deformation and degradation of the base layer and the separator can be suppressed, and a rise in battery temperature caused by spread of a short-circuited portion can be suppressed. When the insulating tape having a porous layer formed of an acrylic resin was used, the suppressing effect on the rise in temperature was considerable.

### REFERENCE SIGNS LIST

10 secondary battery
11 positive electrode
12 negative electrode
13 separator
14 electrode body
15 case body
16 sealing body
17, 18 insulating plate
19 positive electrode lead
20 negative electrode lead
21 protrusion portion
22 filter
23 lower valve body
24 insulating member
25 upper valve body
26 cap
27 gasket
30 positive electrode current collector
31 positive electrode mixture layer
32, 37 exposed portion
35 negative electrode current collector
36 negative electrode mixture layer
40, 50 insulating tape
41, 51 base layer
42 adhesive layer
43 porous layer
44, 54 pore
53 porous region

1. A secondary battery comprising:
an electrode body formed by layering a positive electrode and a negative electrode with a separator therebetween and an electrolytic solution,
wherein each of the positive electrode and the negative electrode includes a current collector, a mixture layer formed on the current collector, and an electrode lead connected to an exposed portion at which a surface of the current collector is exposed,
wherein insulating tape adhered to at least one of the electrode lead and the exposed portion is provided in at least one of the positive electrode and the negative electrode, and
wherein the insulating tape includes a base layer formed of an insulating organic material, an adhesive layer, and a porous region that is interposed between the base layer and the adhesive layer and that has a pore that the electrolytic solution is allowed to enter.

2. The secondary battery according to claim 1,
wherein the porous region is formed of a protrusion and a depression in a surface of the base layer opposite the adhesive layer or is formed by interposing a porous layer formed of a resin between the base layer and the adhesive layer.

3. The secondary battery according to claim 2,
wherein a thickness of the porous region is 0.5 μm or more or
wherein a ratio of the thickness of the porous region to a total thickness of the base layer and the porous layer is 2% to 50%.

4. The secondary battery according to claim 2,
wherein a porosity of the porous layer is 5% or more by volume of a layer volume.

5. The secondary battery according to claim 2,
wherein the porous layer is formed of, as a main component, a kind selected from a group consisting of polyimide, polyamide, aramid resin, epoxy resin, and acrylic resin.

6. The secondary battery according to claim 1,
wherein the insulating tape is adhered to at least the positive electrode.
